(19) United States
(12) Patent Application Publication
(10) Pub. No.: US 2009/0051341 A1
(43) Pub. Date: Feb. 26, 2009

(54) BANDGAP REFERENCE CIRCUIT

(75) Inventors: CHIA-WEI CHANG, Taichung (TW); UEI-SHAN UANG, Taichung (TW); YAN-HUA PENG, Hsinchu (TW)

Correspondence Address: WPAT, PC, 7225 BEVERLY ST., ANNANDALE, VA, 22003, US

(73) Assignee: FARADAY TECHNOLOGY CORPORATION, Hsinchu (TW)

(21) Appl. No.: 12/184,528

(22) Filed: Aug. 1, 2008

(30) Foreign Application Priority Data
Aug. 22, 2007 (TW) 096131134

(51) Int. Cl. G05F 3/20

(52) U.S. Cl. 323/313

(57) ABSTRACT

A bandgap reference circuit includes a PTAT current generating circuit for generating a PTAT current; a CTAT circuit generating circuit for generating a CTAT current; a node for receiving the PTAT current and the CTAT current; and, a first resistor connected between the node and a ground, wherein a reference voltage is derived from the first resistor when a superposed current of the PTAT current and the CTAT current is flowing through the first resistor.

### FIELD OF THE INVENTION

The present invention relates to a bandgap reference circuit, and more particularly to a bandgap reference circuit supplied by a low supply voltage.

### BACKGROUND OF THE INVENTION

As known in the art, a bandgap reference circuit provides a steady reference voltage (V_{ref}) that will not be varied by manufacturing process, temperature or the supply voltage. In the hybrid circuit field, the bandgap reference circuit is designed into many circuits such as voltage regulators, digital to analog converters or low drift amplifier.

Please refer to FIG. 1, which illustrates a conventional bandgap reference circuit implemented by PMOS FETs, PNP BJTs and an operation amplifier. Generally speaking, the bandgap reference circuit includes a mirroring circuit 12, an operation amplifier 15 and an input circuit 20. The mirroring circuit 12 comprises three PMOS FETs, M1, M2 and M3. In this example, M1, M2 and M3 have the same aspect ratio (W/L), and the gates of M1, M2 and M3 are connected to one another and the sources of M1, M2 and M3 are connected to a supply voltage (Vss). The drains of M1, M2 and M3 output current Iₓ, I_{y} and I_{z} respectively. Also, an output terminal of the operation amplifier 15 is connected to the gates of M1, M2 and M3 while a positive input terminal of the operation amplifier 15 is connected to the drain of M2 and a negative input terminal of the operation amplifier 15 is connected to the drain of M1. Furthermore, input circuit 20 comprises two PNP BJTs, Q1 and Q2. The area of Q1 is m times larger than that of Q2. The bases and collectors of Q1 and Q2 are connected to the ground to make Q1 and Q2 form diode connections. The emitter of Q2 is connected to the negative input terminal of the operation amplifier 15. A first resistor (RI) is connected between the emitter of Q1 and the positive of the operation amplifier 15. Furthermore, BJT Q3 having the same area with Q2 includes a bases and a collector connected to the ground. A second resistor (R2) is connected between an emitter of Q3 and a drain of M3 and the drain of M3 is capable of outputting the reference voltage (V_{ref}).

As shown in FIG. 1, since M1, M2 and M3 have the same aspect ratio, the current Iₓ, I_{y} and I_{z} outputted by the M1, M2 and M3 are the same. That is Iₓ=I_{y}=I_{z}—(1).

Further, under the premise that the operation amplifier 15 has an infinite gain, a voltage difference between the positive and negative input terminals of the operation amplifier 15 will be the same. That is V_{y}=Vₓ. Thus, R₁I_{y}+V_{EB1}=V_{EB2}—(2).

Since Q1 and Q2 form diode connections and the area of Q1 is m times larger than Q2, Iₓ=Iₛe^{V}^{_{EB2}}^{/V}^{ᵣ} and I_{y}=mIₛe^{V}^{_{EB1}}^{/V}^{_{T}}, which derive V_{BE1}=V_{T}ln(I_{y}/mIₛ)—(3), and V_{BE2}=V_{T}ln(Iₓ/Iₛ)—(4), can be obtained; where the Iₛ is a saturation current of Q2 and the V_{T} is a thermal voltage. Finally, combining equations of (1), (2), (3) and (4), the current I_{y}=(I/R₁)V_{T}In m—(5), and the reference voltage V_{ref}=(R₂/R₁)V_{T}ln m+V_{EB3}—(6) are obtained.

FIG. 2A is a diagram showing reference voltage (V_{ref}) generated from the components of the bandgap reference circuit. The voltage (V_{BE}) is generated by the base-emitter voltage generator 32; the thermal voltage (V_{T}) is generated by the thermal voltage generator 34; the thermal voltage (V_{T}) is multiplied by a temperature-independent scalar (K) 36; and the reference voltage (V_{ref}), according to Eq. (6), is derived from adding V_{BE} to V_{T} multiplied by K. That is, V_{ref}=V_{BE}+KV_{T}, where K=(R₂/R₁)ln m.

FIG. 2B is a sketch of V_{ref} versus temperature. Obviously, the voltage V_{BE} generated by the base-emitter voltage generator 32 is inversely proportional to temperature, that is, V_{BE} has a characteristic of negative-temperature coefficient. Conversely, the thermal voltage V_{T} generated by the thermal voltage generator 34 is proportional to temperature, that is, the thermal voltage V_{T} has a characteristic of positive-temperature coefficient. A zero temperature coefficient is accordingly obtained if V_{BE} is added to V_{T} multiplied by a constant K, in other words, the reference voltage (V_{ref}) is almost a constant at any temperature.

A proportional to absolute temperature (PTAT) current generating circuit is also widely designed in hybrid circuit to produce a current that varies according to temperature. Please refer to FIG. 3, which illustrates a conventional PTAT current generating circuit implemented by PMOS FETs, PNP BJTs and an operation amplifier. The structure of PTAT current generating circuit is similar to the bandgap reference circuit illustrated in FIG. 1; the only difference being that the drain of PMOS FET M3 directly outputs PTAT current (Iₚₜₐₜ). The connection of the operation amplifier 15 and the input circuit 20 are the same as that in FIG. 1.

By the same logic, three currents Iₓ, I_{y}, and Iₚₜₐₜ are the same. That is Iₓ=I_{y}=Iₚₜₐₜ. Thus, a PTAT current Iₚₜₐₜ=(1/R₁)V_{T}ln m can be obtained. According to the characteristic that the current of BJT is proportional to absolute temperature, the PTAT current generating circuit can be obtained by modifying the conventional bandgap reference circuit.

Generally, the forward bias voltage of a BJT transistor is about 0.83V at −40□, and the voltage drop between the supply voltage (V_{SS}) and the input circuit 20 (that is, the mirroring circuit 12 and the operation amplifier 15) is at least 0.17V. In other words, to operate the bandgap reference circuit in FIG. 1 normally, the supply voltage (Vss) is at least 1V (0.83V+0.17V), that is, the supply voltage of the prior-art bandgap reference circuit is at least 1V.

With the development of the semiconductor fabrication process from 0.13 μm, 90 nm, 60 nm, and even to 45 nm, 30 nm, the operating voltage of analog ICs is accordingly decreasing. However, the relatively low operating voltage may affect the normal operation of the prior-art bandgap reference circuit.

In order to prevent the problem of the prior-art bandgap reference circuit must be operated in a relatively high supply voltage, the BIT transistors in the input circuit 20 can be replaced by the Schottky diodes having a lower forward bias voltage, it follows that the bandgap reference circuit can be operated in a relatively low supply voltage. Similarly, the BJT transistors in the input circuit 20 can be also replaced by the dynamic threshold MOS (DT MOS).

However, the fabrication process of the Schottky diode or the DT MOS is not compatible of the standard semiconductor fabrication process. That is, extra fabrication steps and the corresponding masks for the extra fabrication steps are required to the manufactures of the Schottky diode or the DT MOS in the standard semiconductor fabrication process.

FIG. 4A is a sketch showing the \sqrt{I_{D}}−V_{GS} characteristic of a MOSFET, where \sqrt{I_{D}} is the root value of the drain current and V_{SG} is the source-gate voltage of the MOSFET. Generally, the MOSFET is operating in the subthreshold region (or weak inversion region) when V_{SG} is less than a voltage V_{ON}; conversely, the MOSFET is operating in the strong inversion region when V_{SG} is greater than the voltage V_{ON}. FIG. 4B is a sketch showing the log(I_{D})−V_{SG} characteristic for a MOSFET, where log(I_{D}) is the log value of the drain current. Obviously, log(I_{D}) is proportional to V_{SG} in the subthreshold region, in other words, the MOSFET behaves as a diode when the MOSFET is operating in the subthreshold region.

Therefore, to make all devices in the input circuit 20 compatible of the standard semiconductor fabrication process, conventionally the BJTs in the input circuit 20 are replaced by MOSFTSs operating in the subthreshold region, accordingly, the bandgap reference circuit or the PTAT current generating circuit can be operated by providing a relatively low supply voltage (Vss).

When MOSFET is operating in the subthreshold region, the drain current is given by:

$${I}_{D} ≅ {I}_{D 0} ( \frac{W}{L} ) exp ( \frac{{V}_{SG}}{ξ \cdot {V}_{T}} ) ,$$

where I_{D0} is a process-dependent parameter, V_{T} is the thermal voltage

$$( {V}_{T} = \frac{kT}{q} ) ,$$

and 86 is non-ideality factor and in the range of 1˜3.

FIG. 5 is a schematic diagram showing the configuration of a prior-art bandgap reference circuit constituted by PMOS transistors, and an operation amplifier. The bandgap reference circuit includes a mirroring circuit 42, an operation amplifier 45 and an input circuit 50. The mirroring circuit 42 comprises three PMOS FETs, M1, M2 and M3. In this example, M1, M2 and M3 have the same aspect ratio (W/L), and the gates of M1, M2 and M3 are connected to one another and the sources of M1, M2 and M3 are connected to a supply voltage (Vss). The drains of M1, M2 and M3 output current Iₓ, I_{y} and I_{z} respectively. Also, an output terminal of the operation amplifier 45 is connected to the gates of M1, M2 and M3 while a positive input terminal of the operation amplifier 45 is connected to the drain of M2 and a negative input terminal of the operation amplifier 45 is connected to the drain of M1. Furthermore, input circuit 50 comprises two PMOS FETs, M4 and M5. The aspect ratio of M4 is n times larger than that of M5. Gates and drains of M4 and M5 are connected to the ground. Furthermore, a source of M5 is connected to the negative input terminal of the operation amplifier 45. A first resistor (R1) is connected between a source of M4 and the positive of the operation amplifier 45. Furthermore, PMOS M6 having the same aspect ratio with M5 includes a gate and a drain connected to the ground. A second resistor (R2) is connected between a source of M6 and the drain of M3 and the drain of M3 is capable of outputting the reference voltage (V_{ref}).

As shown in FIG. 5, since M1, M2 and M3 have the same aspect ratio, the current Iₓ, I_{y} and I_{z} outputted by the M1, M2 and M3 are the same. That is Iₓ=I_{y}=I_{z}—(7).

Further, under the premise that the operation amplifier 45 has an infinite gain, a voltage difference between the positive and negative input terminals of the operation amplifier 45 will be the same. That is V_{y}=Vₓ. Thus, R₁I_{y}+V_{SG4}=V_{SG5}—(8).

Since M4 and M5 are operating in the subthreshold region and the aspect ratio of M4 is n times larger than M5,

$${I}_{x} = {I}_{D 0} ( \frac{W}{L} ) exp ( \frac{{V}_{SG 5}}{ξ \cdot {V}_{T}} )$$

and,

$${I}_{y} = {I}_{D 0} ( \frac{nW}{L} ) exp ( \frac{{V}_{SG 4}}{ξ \cdot {V}_{T}} ) ,$$

which derive

$${V}_{SG 5} = ξ \cdot {V}_{T} ln [ \frac{{I}_{x}}{{I}_{D 0} ( W / L )} ] , \qquad ( 9 )$$

and

$${V}_{SG 4} = ξ \cdot {V}_{T} ln [ \frac{{I}_{y}}{{I}_{D 0} ( nW / L )} ] , \qquad ( 10 )$$

can be obtained. Finally, combining equations of (7), (8), (9) and (10), the current I_{y}=(ξ·V_{T}/R₁)ln(n)—(11), and the reference voltage V_{ref}=(R₂/R₁)ξ·V_{T}ln(n)+V_{SG6}—(12) are obtained.

Similarly, the reference voltage (V_{ref}), according to Eq. (12), is derived from a thermal voltage generator having a characteristic of positive-temperature coefficient and a gate-source voltage generator having a characteristic of negative-temperature coefficient. In other words, the reference voltage (V_{ref}) is almost a constant at any temperature.

Please refer to FIG. 6, which illustrates a conventional PTAT current generating circuit. The structure of PTAT current generating circuit is similar to the bandgap reference circuit illustrated in FIG. 5; the only difference being that the drain of PMOS FET M3 directly outputs PTAT current (Iₚₜₐₜ). The connection of the operation amplifier 45 and the input circuit 50 are the same as that in FIG. 5. By the same logic, three currents Iₓ, I_{y}, and Iₚₜₐₜ are the same. That is Iₓ=I_{y}=Iₚₜₐₜ. Thus, a PTAT current Iₚₜₐₜ=(ξ·V_{T}/R₁)ln(n) can be obtained.

According to the description in IEEE J. Solid-State Circuits, vol. 38, no. 1, pp. 151-154, 2003 and Integrated Circuit Design and Technology, 2006. ICICDT apos; 06. 2006 IEEE International Conference on Volume, Issue, 24-26 May 2006 Page(s): 1-4, the threshold voltage model built in MOSFET operating in the subthreshold region is:

$${V}_{TH} ≅ {V}_{TH} ( {T}_{0} ) + {K}_{T} ( \frac{T}{{T}_{0}} - 1 ) , \qquad ( 13 )$$

### Where K_{T}<0.

Moreover, source-gate voltage (V_{SG}), threshold voltage (V_{TH}), and temperature have a relationship of:

$${V}_{SG} ( T ) ≅ {V}_{TH} ( T ) + {V}_{OFF} + [ {V}_{SG} ( {T}_{0} ) - {V}_{TH} ( {T}_{0} ) - {V}_{OFF} ] \frac{T}{{T}_{0}} , \qquad ( 14 )$$

Where V_{OFF} is a corrective constant term of the threshold voltage between the weak inversion (subthreshold) region and the strong inversion region.

Combining equations of (13) and (14),

$${V}_{SG} ( T ) ≅ {V}_{SG} ( {T}_{0} ) + {K}_{G} ( \frac{T}{{T}_{0}} - 1 ) , \qquad ( 15 )$$

Where K_{G}<0 and K_{G}≅K_{T}+V_{SG}(T₀)−V_{TH}(T₀)−V_{OFF}, is obtained.

Observe Eqs. (13) and (15), both the threshold voltage (V_{TH}) and the source-gate voltage (V_{SG}) have negative-temperature coefficients; and observe Eq. (14), the source-gate voltage (V_{SG}) is a function of the threshold voltage (V_{TH}) and temperature.

Even the fabrication process of the bandgap reference circuit and PTAT current generating circuit depicted in FIG. 5 and 6 are compatible of the standard semiconductor fabrication process, the threshold voltage may not be a constant due to the variation of characteristic parameters resulted in the deviation of fabrication process. For example, under the critical situations of a same semiconductor fabrication process, FETs can be categorized to slow-corner FETs (S corner), fast-corner FETs (F corner), and typical-corner FETs (T corner) in a standard semiconductor fabrication process. The S-corner FET is defined as the FET having a weakest and slowest drive strength performance among a batch of FETs manufactured by a same standard semiconductor fabrication process; the F-corner FET is defined as the FET having a strongest and fastest drive strength performance among a batch of FETs manufactured by a same standard semiconductor fabrication process; the T-corner FET is defined as the FET having a normal drive strength performance among a batch of FETs manufactured by a standard semiconductor fabrication process.

FIG. 7A is a diagram showing the threshold voltage versus the temperature for the S-corner FET, the F-corner FET, and the T-corner FET. The threshold voltage (V_{TH}) of the S-corner FET is about 625 mV when the S-corner FET is operating at −20□, and the threshold voltage (V_{TH}) is decreasing to 525 mV along with the temperature increasing to 100□; the threshold voltage (V_{TH}) of the T-corner FET is about 520 mV when the T-corner FET is operating at −20□, and the threshold voltage (V_{TH}) is decreasing to 425 mV along with the temperature increasing to 100□; the threshold voltage (V_{TH}) of the F-corner FET is about 420 mV when the F-corner FET is operating at −20□, and the threshold voltage (V_{TH}) is decreasing to 325 mV along with the temperature increasing to 100□.

From Eq. (14), the source-gate voltage (V_{SG}) is a function of the threshold voltage (V_{TH}) and temperature. Accordingly, different values of the reference voltage (V_{ref}) may be derived from the bandgap reference circuits if the bandgap reference circuits are constituted by S-corner FETs, F-corner FETs, or T-corner FETs, which are manufactured in a same semiconductor fabrication process.

FIG. 5B is a diagram showing the reference voltage (V_{ref}) versus the temperature, where the reference voltages (V_{ref}) are derived from the bandgap reference circuits respectively implemented by S-corner FETs, F-corner FETs, and the T-corner FETs. Obviously, the reference voltage (V_{ref}) derived from the bandgap reference circuit implemented by S-corner FETs is independent of temperature but the value is about 280 mV; the reference voltage (V_{ref}) derived from the bandgap reference circuit implemented by T-corner FETs is independent of temperature but the value is about 240 mV; the reference voltage (V_{ref}) derived from the bandgap reference circuit implemented by F-corner FETs is independent of temperature but the value is about 205 mV.

Because the reference voltage (V_{ref}) derived from the bandgap reference circuit depicted in FIG. 5 cannot be accurately remained at a constant and have a ±15% error due to the deviation resulted in the standard semiconductor fabrication process, developing a bandgap reference circuit capable of providing a constant reference voltage is the main purpose of the present invention.

### SUMMARY OF THE INVENTION

Therefore, the present invention provides a bandgap reference circuit that is compatible of the standard semiconductor fabrication process. The reference voltage derived from the bandgap reference circuit is independent of temperature and the deviation resulted in the semiconductor fabrication process.

The present invention provides a bandgap reference circuit includes a PTAT current generating circuit for generating a PTAT current; a CTAT circuit generating circuit for generating a CTAT current; a node for receiving the PTAT current and the CTAT current; and, a first resistor connected between the node and a ground, wherein a reference voltage is derived from the first resistor when a superposed current of the PTAT current and the CTAT current is flowing through the first resistor.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram showing the configuration of a prior-art bandgap reference circuit;

FIG. 2A is a diagram showing reference voltage (V_{ref}) generated from the components of the bandgap reference circuit;

FIG. 2B is a sketch of V_{ref} versus temperature;

FIG. 3 is a schematic diagram showing the configuration of a PTAT current generating circuit;

FIG. 4A is a sketch showing the \sqrt{I_{D}}−V_{GS} characteristic of a MOSFET;

FIG. 4B is a sketch showing the log(I_{D})−V_{GS} characteristic for a MOSFET;

FIG. 5 is a schematic diagram showing the configuration of a prior-art bandgap reference circuit;

FIG. 6 is a schematic diagram showing the configuration of a PTAT current generating circuit;

FIG. 7A is a diagram showing the threshold voltage versus the temperature for the S-corner FET, F-corner FET, and the T-corner FET;

FIG. 7B is a diagram showing the reference voltage (V_{ref}) versus the temperature, where the reference voltages (V_{ref}) are derived from the bandgap reference circuits respectively implemented by S-corner FET, F-corner FET, and the T-corner FET;

FIG. 8 is a schematic diagram showing the configuration of a bandgap reference circuit of the present invention;

FIG. 9A is a diagram showing the threshold-voltage-difference value (ΔV_{TH}(T)) of two S-corner FETs, F-corner FETs, and T-corner FETs versus the temperature, where the S-corner FETs, the F-corner FETs, and the T-corner FETs have a different threshold voltage V_{TH} due to the deviation resulted in the semiconductor fabrication process; and

FIG. 9B is a diagram showing the reference voltage (V_{ref}) versus the temperature, where the reference voltage is derived from the bandgap reference circuit implemented by the S-corner FETs, the F-corner FETs, or the T-corner FETs having different threshold voltages due to the deviation resulted in the semiconductor fabrication process.

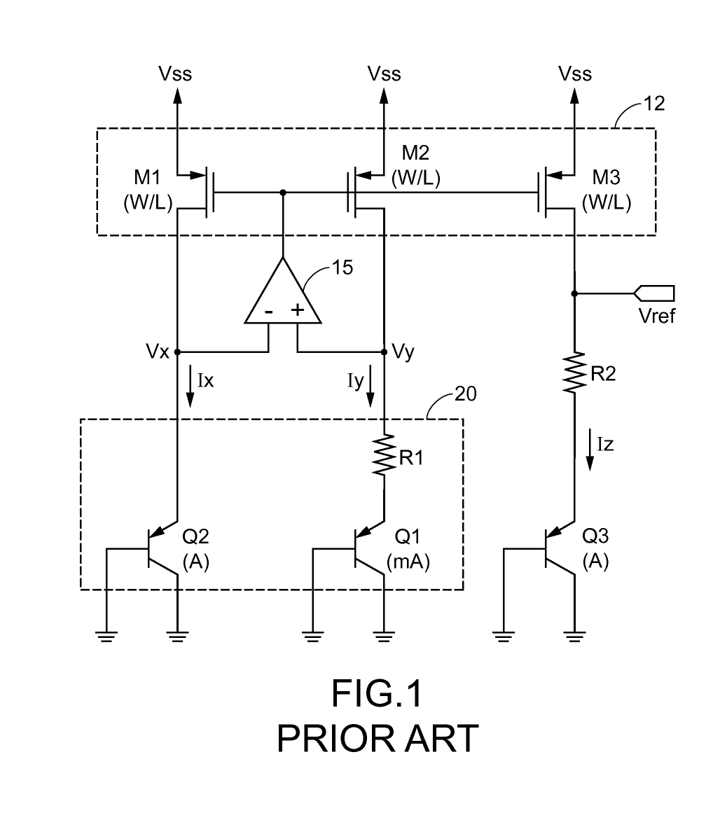

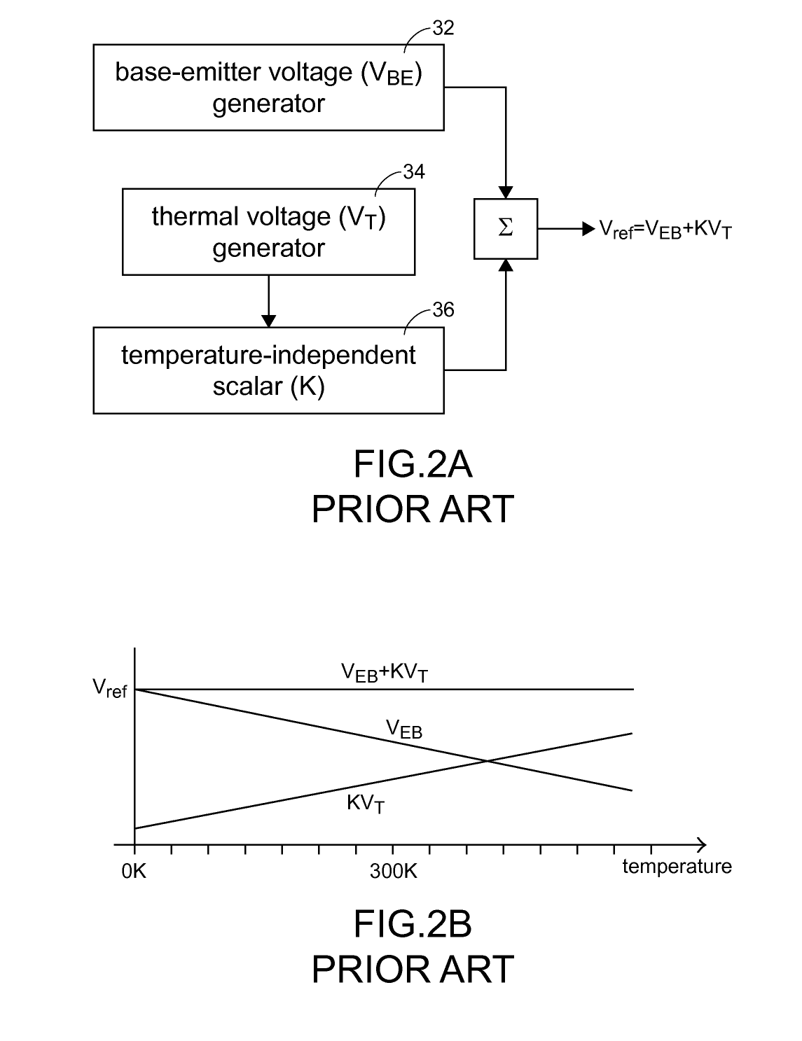

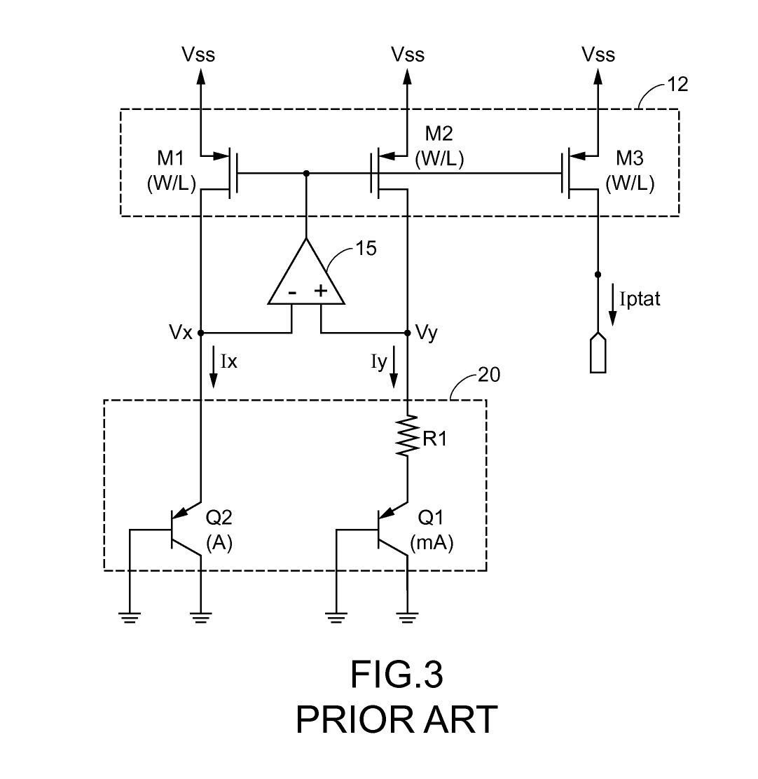

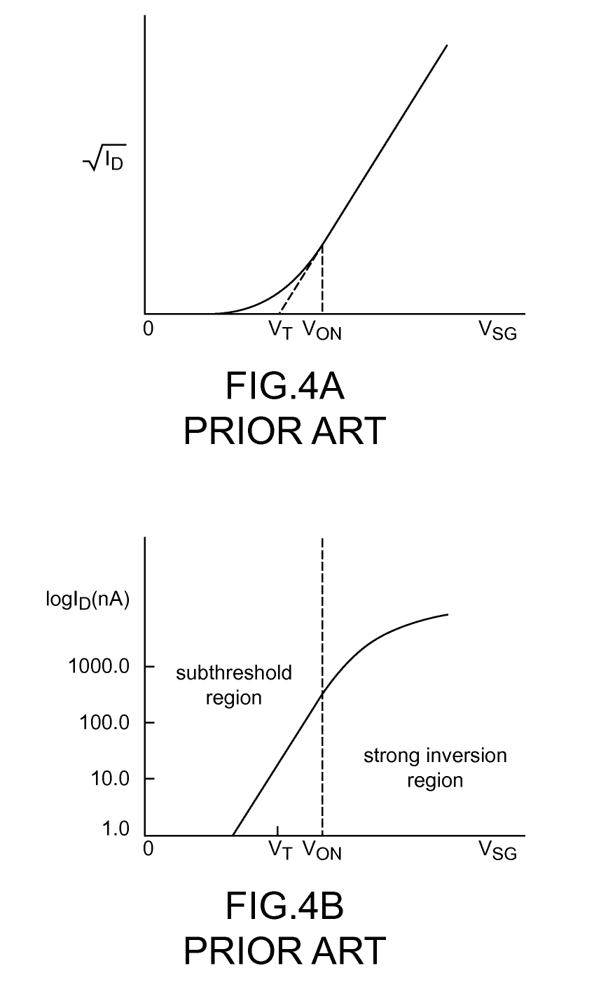

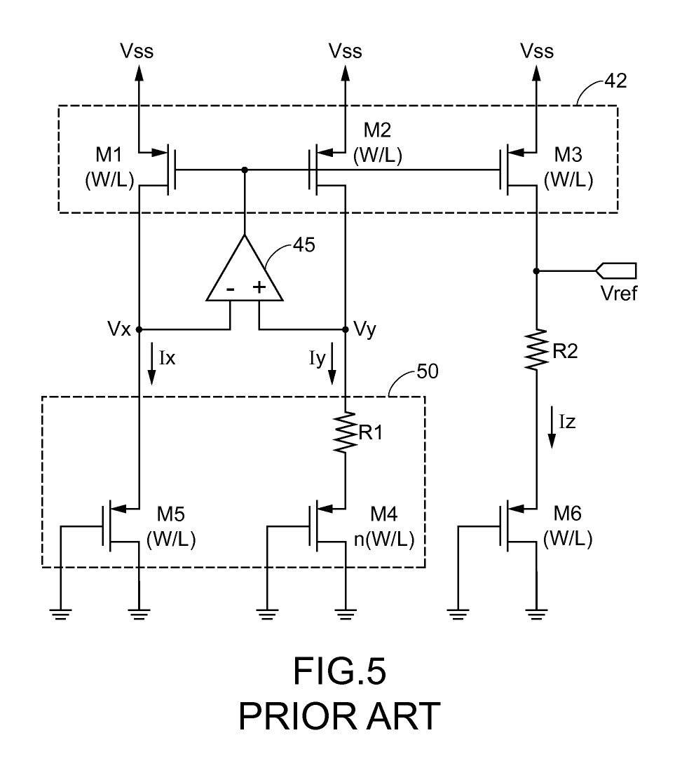

### DETAILED DESCRIPTION OF PREFERRED EMBODIMENTS

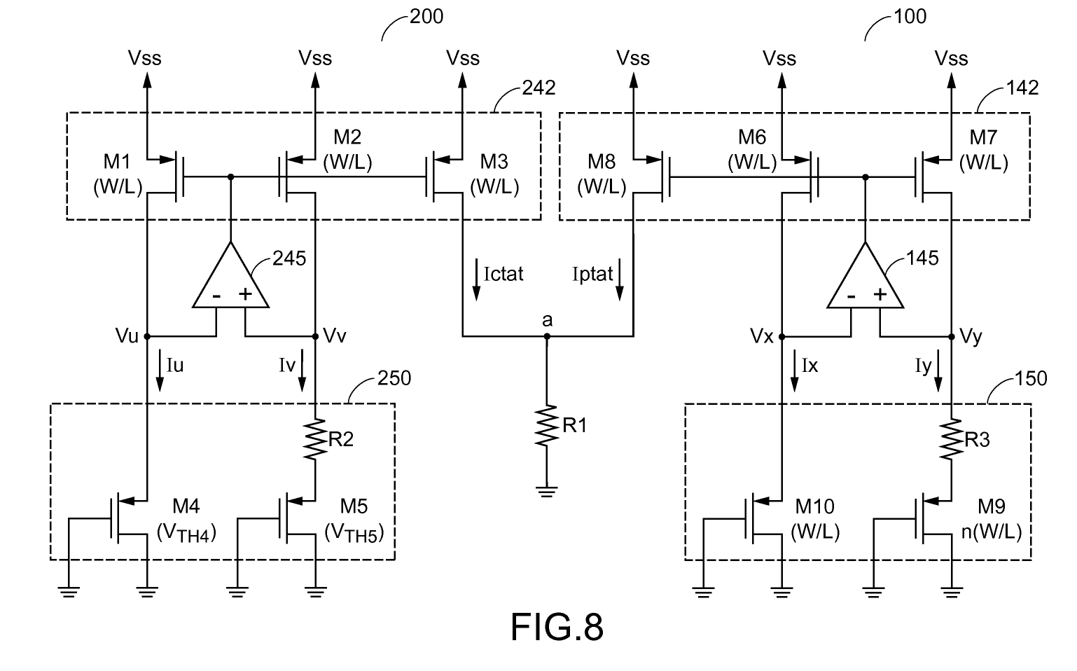

FIG. 8 is a schematic diagram showing the configuration of a bandgap reference circuit of the present invention. The bandgap reference circuit includes: a PTAT current generating circuit 100 for generating a PTAT current (Iₚₜₐₜ), where the Iₚₜₐₜ is proportional to the absolute temperature; a complementary-to-absolute-temperature (CTAT) current generating circuit 200 for generating a CTAT current (I_{ctat}), where Ictat is inversely proportional to the absolute temperature.

The CTAT current generating circuit 200 further includes: a mirroring circuit 242, an operation amplifier 245, and an input circuit 250. The mirroring circuit 242 includes three PMOS transistors M1, M2, and M3. In this example, M1, M2 and M3 have the same aspect ratio (W/L), and the gates of M1, M2 and M3 are connected to one another and the sources of M1, M2 and M3 are connected to a supply voltage (Vss). The drains of M1, M2 and M3 output current Iᵤ, Iᵥ and I_{ctat} respectively. Also, an output terminal of the operation amplifier 245 is connected to the gates of M1, M2 and M3 while a positive input terminal of the operation amplifier 245 is connected to the drain of M2 and a negative input terminal of the operation amplifier 245 is connected to the drain of M1. Furthermore, input circuit 250 comprises two PMOS FETs, M4 and M5. The threshold voltage of M4 is larger than the threshold voltage of M5 (V_{TH4}>V_{TH5}). Gates and drains of M4 and M5 are connected to the ground. Furthermore, a source of M4 is connected to the negative input terminal of the operation amplifier 245. A second resistor (R2) is connected between a source of M5 and the positive of the operation amplifier 245 and the drain of M3 is capable of outputting the CTAT current (I_{ctat}).

The PTAT current generating circuit 100 includes a mirroring circuit 142, an operation amplifier 145 and an input circuit 150. The mirroring circuit 142 comprises three PMOS FETs, M6, M7 and M8. In this example, M6, M7 and M8 have the same aspect ratio (W/L), and the gates of M6, M7 and M8 are connected to one another and the sources of M6, M7 and M8 are connected to a supply voltage (Vss). The drains of M6, M7 and M8 output current Iₓ, I_{y} and Iₚₜₐₜ respectively. Also, an output terminal of the operation amplifier 145 is connected to the gates of M6, M7 and M8 while a positive input terminal of the operation amplifier 145 is connected to the drain of M7 and a negative input terminal of the operation amplifier 145 is connected to the drain of M6. Furthermore, input circuit 150 comprises two PMOS FETs, M9 and M10. The aspect ratio of M9 is n times larger than that of M10. Gates and drains of M9 and M10 are connected to the ground. Furthermore, a source of M10 is connected to the negative input terminal of the operation amplifier 145. A third resistor (R3) is connected between a source of M9 and the positive of the operation amplifier 145. Also, the drain of M8 is capable of outputting the PTAT current (Iₚₜₐₜ) and Iₚₜₐₜ=(ξ·V_{T}/R₂)ln(n).

Moreover, a node a is connected to the drain of M3 in the mirroring circuit 242 of the CTAT circuit 200 and the drain of M8 in the mirroring circuit 142 of the PTAT circuit 100 for receiving the CTAT current (I_{ctat}) and the PTAT current (Iₚₜₐₜ). Also, a first resistor (R1) is connected between the node a and the ground. That is the superposed current (I_{ctat}+Iₚₜₐₜ) is then flowed to the first resistor R1, and a reference voltage (V_{ref}) is derived from the node a. According to Eq. (15), I_{ctae} is given by:

$${I}_{ctat} = \frac{{V}_{SG 4} - {V}_{SG 5}}{{R}_{2}} = \frac{Δ {V}_{SG} ( {T}_{0} ) - Δ {K}_{G}}{{R}_{2}} + \frac{Δ {K}_{G}}{{R}_{2}} \frac{T}{{T}_{0}} , \qquad ( 16 )$$

### Where ΔK_{G}=K_{G4}−K_{G5}<0, and ΔV_{SG}(T₀)=V_{SG4}(T₀)−V_{SG5}(T₀).

Because the term

$$( \frac{Δ {K}_{G}}{{R}_{2}} \frac{T}{{T}_{0}} )$$

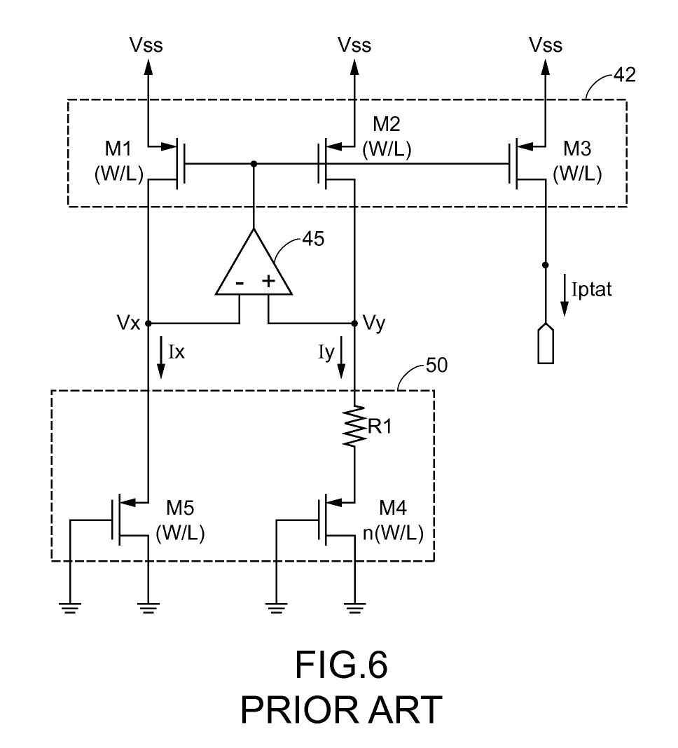

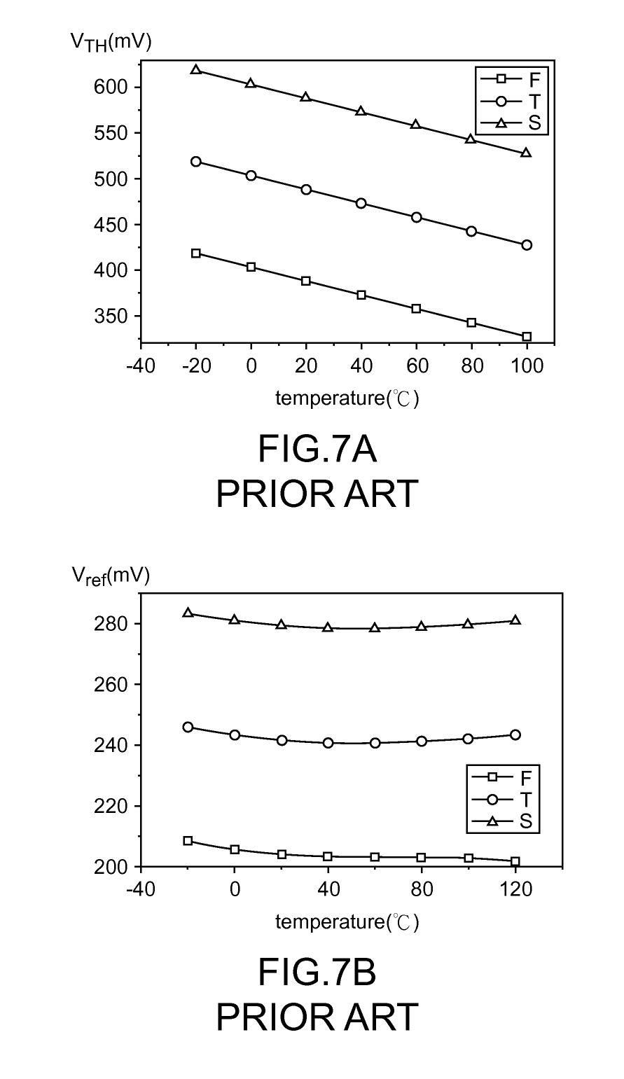

in Eq. (16) is a negative-temperature coefficient, that means CTAT current (I_{ctat}) is inversely proportional to temperature. Moreover, according to FIG. 6, PTAT current (Iₚₜₐₜ) is given by: Iₚₜₐₜ=(ξ·V_{T}/R₃)ln(n).

Therefore, the reference voltage (V_{ref}) is given by:

$${V}_{ref} = ( {I}_{ctat} + {I}_{ptat} ) {R}_{1} = ( \frac{Δ {V}_{SG} ( {T}_{0} ) - Δ {K}_{G}}{{R}_{2}} + \frac{Δ {K}_{G}}{{R}_{2}} \frac{T}{{T}_{0}} + \frac{ξ \cdot ln ( n )}{{R}_{3}} {V}_{T} ) \cdot {R}_{1} ,$$

which can be written as

$${V}_{ref} = \frac{{R}_{1}}{{R}_{2}} [ Δ {V}_{SG} ( {T}_{0} ) - Δ {K}_{G} + Δ {K}_{G} \frac{T}{{T}_{0}} + \frac{{R}_{2} \cdot ξ \cdot ln ( n )}{{R}_{3}} {V}_{T} ] . \qquad ( 17 )$$

In Eq. (17), the first term and second term [ΔV_{SG}(T₀)−ΔK_{G}] is a constant that is independent of temperature; the third term

$$[ Δ {K}_{G} \frac{T}{{T}_{0}} ]$$

is a negative-temperature coefficient (ΔK_{G}<0); the fourth term

$$\frac{{R}_{1} \cdot ξ \cdot ln ( n )}{{R}_{2}} {V}_{T}$$

is a positive-temperature coefficient. Therefore, through a proper arrangement of the size of transistors and the values of resistors in the bandgap reference circuit depicted in FIG. 8, a zero-temperature coefficient can be derived from the positive-temperature coefficient adding to the negative-temperature coefficient. That is, (I_{ctat}+Iₚₜₐₜ) is independent of temperature, accordingly, a temperature-independent reference voltage V_{ref}=(I_{ctat}+Iₚₜₐₜ)·R₁ is derived from the bandgap reference circuit of the present invention.

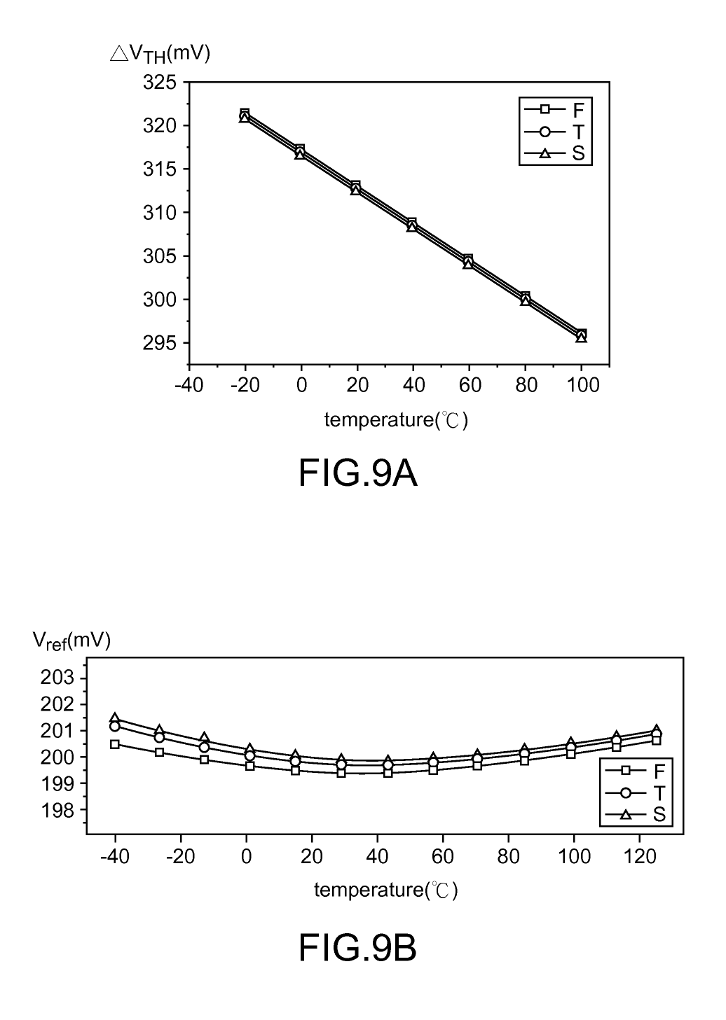

Furthermore, the reference voltage (V_{ref}) derived from the bandgap reference circuit of the present invention depicted in FIG. 8 is also independent of the deviation resulted in the standard semiconductor fabrication process. FIG. 9A is a diagram showing the threshold-voltage-difference value ΔV_{TH}(T) of two S-corner FETs, F-corner FETs, and T-corner FETs versus the temperature, where the S-corner FETs, the F-corner FETs, and the T-corner FETs have different threshold voltages V_{TH} due to the deviation resulted in the standard semiconductor fabrication process. Obviously, the threshold-voltage-difference value ΔV_{TH}(T) of the S-corner FET, the F-corner FET, and the T-corner FET have almost a same curve. In other words, the bandgap reference circuit of the present invention is implemented by a characteristic of: all the threshold-voltage-difference values ΔV_{TH}(T) of two S-corner FETs, F-corner FETs, or T-corner FETs have a same specific relationship with the temperature, no matter the S-corner FET, F-corner FET, and the T-corner FET have different threshold voltages resulted in the deviation of the semiconductor fabrication process. Two FETs having a different threshold voltage can be manufactured through controlling the thickness of the silicon dioxide layer in the standard semiconductor fabrication process.

FIG. 9B is a diagram showing the reference voltage (V_{ref}) versus the temperature, where the reference voltage is derived from the bandgap reference circuit implemented by S-corner FETs, F-corner FETs, or T-corner FETs having different threshold voltages resulted in the deviation of the standard semiconductor fabrication process. The bias error of the reference voltage (V_{ref}) is about ±2%, which is almost can be neglected. In other words, the reference voltage (V_{ref}) derived from the bandgap reference circuit of the present invention is almost independent of temperature and the deviation resulted in the standard semiconductor fabrication process.

The present invention provides a bandgap reference circuit, which can be manufactured in a standard semiconductor fabrication process. The bandgap reference circuit of the present invention is implemented by the PTAT circuit for generating the PTAT current (Iₚₜₐₜ), and the CTAT circuit for generating the CTAT current (I_{ctat}). The temperature-independent reference voltage (V_{ref}) is derived from the PTAT current (Iₚₜₐₜ) superposed to the CTAT (Iₚₜₐₜ) flowing through a resistor. Moreover, the bandgap reference circuit of the present invention is capable of operated by a relatively low operating voltage. Moreover, through the threshold-voltage-difference value (ΔV_{TH}(T)) of transistors compensating the deviation resulted in the standard semiconductor fabrication process, the bandgap reference circuit of the present invention is almost independent of temperature and the deviation resulted in the standard semiconductor fabrication process.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A bandgap reference circuit, comprising:
a PTAT current generating circuit for generating a PTAT current;
a CTAT circuit generating circuit for generating a CTAT current;
a node for receiving the PTAT current and the CTAT current; and
a first resistor connected between the node and a ground, wherein a reference voltage is derived from a superposed current of the PTAT current and the CTAT current flowing through the first resistor.

2. The bandgap reference circuit according to claim 1, wherein the CTAT current generating circuit further comprises:
an input circuit having a first FET, a second FET, and a second resistor, wherein a first node is connected to the first FET with a first threshold voltage, the second resistor is connected between a second node and the second FET with a second threshold voltage;
a mirroring circuit, for controlling two output currents respectively derived from the first and second nodes, and maintaining the two output currents to a specific current ratio; and
an operation amplifier connected to the first node, the second node of the input circuit, and the mirroring circuit, for controlling two voltages respectively at the first and second nodes of the input circuit to a specific voltage ratio;
wherein the first FET and the second FET are both operating in the subthreshold region, the first threshold voltage is larger than the second threshold voltage.

3. The bandgap reference circuit according to claim 2, wherein the first and second FET are PMOS transistors, a source of the first FET is connected to the first node, gates and drains of the first FET and the second FET are connected to the ground, and the second resistor is connected between a source of the second FET and the second node.

4. The bandgap reference circuit according to claim 2, wherein the first FET and the second FET have a different thickness of the silicon dioxide layer.

5. The bandgap reference circuit according to claim 2, wherein the mirroring circuit further comprises three PMOS transistors, gates of the three PMOS transistors are connected together, sources of the three PMOS transistors are connected to a supply voltage, drains of the three PMOS are the first node, the second node and a output terminal for outputting currents with the specific current ratio.

6. The bandgap reference circuit according to claim 5, wherein an output terminal of the operation amplifier is connected to gates of the three PMOS transistors, two input terminals of the operation amplifier are respectively connected to the first node and the second node.

7. The bandgap reference circuit according to claim 5, wherein the specific current ratio is determined by the three aspect ratios of the three PMOS transistors.
